(19) United States
(12) Patent Application Publication
(10) Pub. No.: US 2007/0099044 A1
(43) Pub. Date: May 3, 2007

(54) Fuel cartridge monitoring device for fuel cells

(76) Inventor: Chun-Chin Tung, Taipei (TW)

Correspondence Address: G. LINK CO. LTD., 3550 BELL ROAD, MINOOKA, IL, 60447, US

(21) Appl. No.: 11/263,936

(22) Filed: Nov. 2, 2005

(51) Int. Cl. H01M 8/04; B01D 35/14; H01M 2/36; H01M 10/48

(52) U.S. Cl. 429/22; 210/86; 429/72; 429/90

(57) ABSTRACT

The present invention relates to a fuel cartridge monitoring device for fuel cell, comprising: a fuel monitoring device for fuel cells consisting of a fuel solution mixing means, a fluid metering means, and a fluid feeding means; a fuel cartridge for storing high concentration of liquid fuel; a pure water cartridge for storing pure water; a supply cartridge for storing solution mixture of fuel and pure water; opening the fluid feeding means to allow the fluid in fuel cartridge and pure water cartridge to respectively enter the supply cartridge until the solution mixture of fuel and pure water reaches a predetermined supply level, and then closing the fluid feeding means to stop fluid supply from fuel cartridge and pure water cartridge; a fluid metering means for monitoring the level of fuel solution in the supply cartridge; and when the fluid metering means determines that the fuel solution level falls below the predetermined level, selectively opening said fluid feeding means.

### FIELD OF THE INVENTION

The present invention relates to a fuel cartridge monitoring device for fuel cells, more particularly a device that integrates electrical circuit, sensor, and logic device to achieve the purpose of supplying fuel of specific concentrations to the fuel cell.

### BACKGROUND OF THE INVENTION

Conventional fuel cell uses hydrogen-rich fuel and undergoes redox reactions to form a current loop for power supply. These types of fuel cell need liquid fuel, such as methanol for reaction. Thus fuel cells typically come with vessel for storing liquid fuel and device for controlling the concentration of fuel. In the age of consumer electronics, the demands for portable power supply escalate dramatically. The industry has been responding by introducing portable fuel cells. But the great majority of fuel cell technologies are inadequate in the area of fuel replenishment. In light of the drawback of conventional fuel cells, a fuel cartridge structure for fuel cells is therefore proposed.

### SUMMARY OF THE INVENTION

The primary object of the present invention is to provide a fuel cartridge monitoring device for fuel cells that can store and supply fuel for fuel cells.

Another object of the present invention is to provide a fuel cartridge monitoring device for fuel cells that has a means for mixing fuel and pure water to control the concentration of fuel output.

A further object of the present invention is to provide a fuel cartridge monitoring device for fuel cells that has a fluid metering device to control the flow of fluid output.

Yet another object of the present invention is to provide a fuel cartridge monitoring device that has a monitoring device to monitor or control the electrical elements of the fuel device.

In accordance with the aforesaid objects, the present invention discloses a fuel cartridge monitoring device for fuel cells, comprising: a fuel monitoring device for fuel cells consisting of a fuel solution mixing means, a fluid metering means, and a fluid feeding means; a fuel cartridge for storing high concentration of liquid fuel; a pure water cartridge for storing pure water; a supply cartridge for storing solution mixture of fuel and pure water; opening the fluid feeding means to allow the fluid in fuel cartridge and pure water cartridge to respectively enter the supply cartridge until the solution mixture of fuel and pure water reaches a predetermined level, and then closing the fluid feeding means to stop fluid supply from fuel cartridge and pure water cartridge; a fluid metering means for monitoring the level of fuel solution in the supply cartridge; and when the fluid metering means determines that the fuel solution level falls below a predetermined level, selectively opening the fluid feeding means.

The objects, features and advantages of the invention are described in details below with embodiment and accompanying drawings.

### BRIEF DESCRIPTION OF THE DRAWINGS

FIG. 1 is a diagram showing the structure of a fuel cartridge monitoring device for fuel cells according to one embodiment of the invention;

FIG. 2A is a flow chart showing the control process of the fuel cartridge monitoring device for fuel cells according to one embodiment of the invention;

FIG. 2B is a control flow chart continuing from FIG. 2A; and

FIG. 3 shows a partial exploded view of a fuel cartridge monitoring device for fuel cells according to another embodiment of the invention.

### DETAILED DESCRIPTION OF THE INVENTION

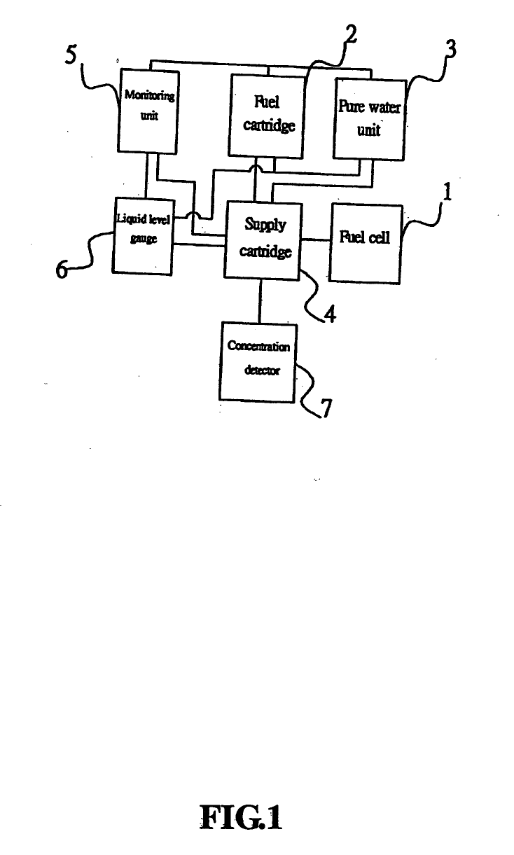

FIG. 1 is a diagram showing the structure of a fuel cartridge monitoring device for fuel cells according to one embodiment of the invention. The present invention discloses a fuel monitoring device for fuel cell 1 comprising a fuel solution mixing means, a fluid metering means, and a fluid feeding means, which is implemented through the devices as illustrated in FIG. 1, including a fuel cartridge 2, a pure water cartridge 3, a supply cartridge 4, a monitoring unit 5, a liquid level gauge 6, and a concentration detector 7.

The fuel cartridge 2 is a storage vessel and filled with high concentration of hydrogen rich liquid fuel, e.g. methanol. The fuel cartridge 2 is also equipped with a flow or volume control means for fluid output. Generally, such flow or volume control means can be achieved by a fluid control valve. The pure water cartridge 3 is a storage vessel and filled with pure water, which also comes with a flow or volume control means for fluid output. The supply cartridge 4 is a storage vessel connected to the fuel cartridge 2 and pure water cartridge 3 and selects the amount of fluid entering respectively from fuel cartridge 2 and pure water cartridge 3 through the corresponding flow or volume control means of fuel cartridge 2 and pure water cartridge 3. The monitoring unit 5 provides a logic decision means and a control means; the logic decision means is for controlling the timing of executing the flow or volume control means of fuel cartridge 2 and pure water cartridge 3, whereas the control means is for controlling the execution of flow or volume control means of fuel cartridge 2 and pure water cartridge 3. The liquid level gauge 6 is a device for determining the liquid level in the fuel cartridge 2, pure water cartridge 3, and supply cartridge 4.

The supply cartridge 4 is disposed with a concentration detector 7 having the concentration detection means to detect the concentration of fuel in the supply cartridge 4 and transmit such information to monitoring unit 5 for it to determine the fuel concentration in the supply cartridge 4.

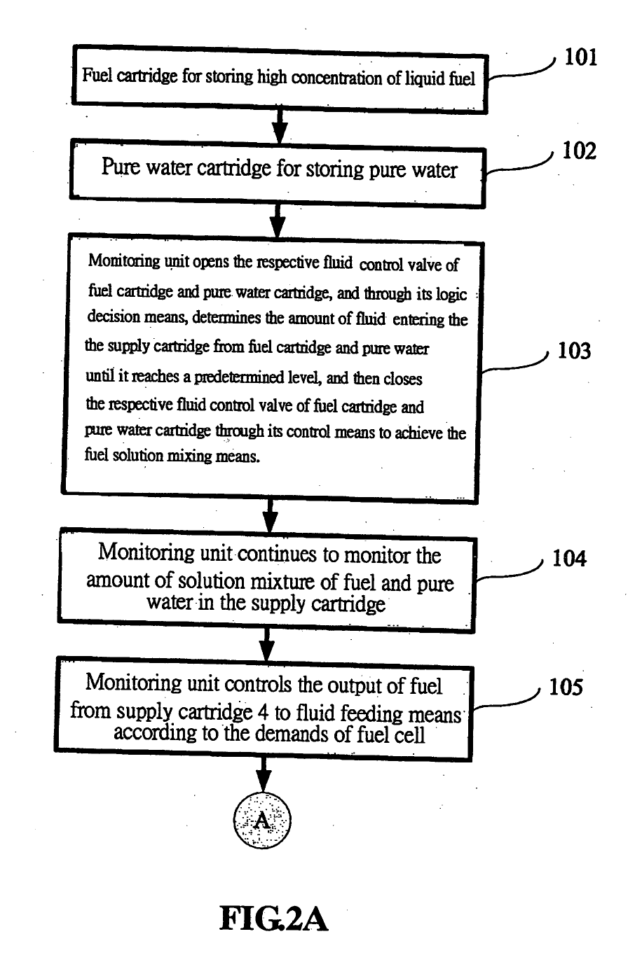

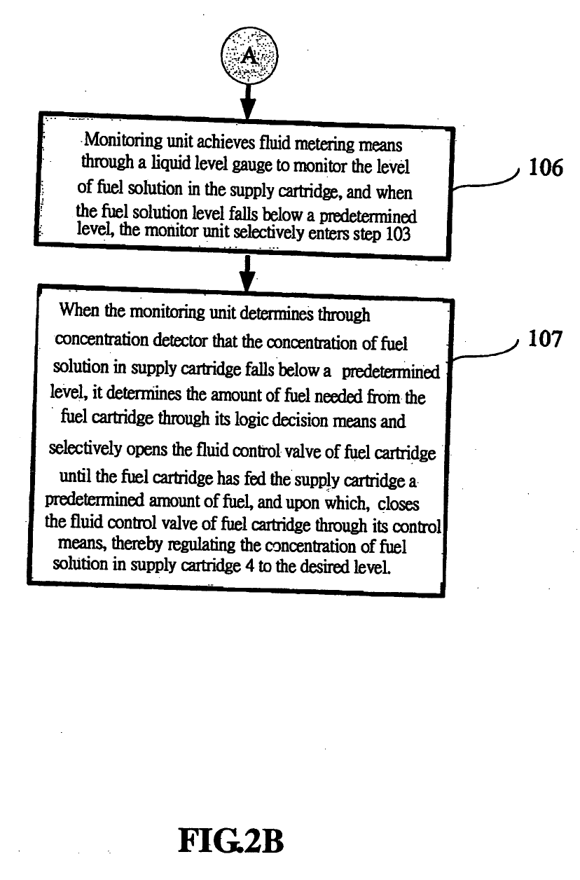

FIG. 2A and FIG. 2B illustrate the control flow chart of the fuel cartridge monitoring device for fuel cells according to an embodiment of the invention. As shown in FIG. 2, the control flow process includes: step 101 where fuel cartridge 2 stores high concentration of liquid fuel, e.g. methanol; step 102 where pure water cartridge stores pure water; step 103 where the monitoring unit 5 opens respectively the fluid control valve of fuel cartridge 2 and pure water cartridge 3, determines the amount of fluid entering supply cartridge 4 from fuel cartridge 2 and pure water cartridge 3 through its logic decision means, and closes respectively the fluid control valve of fuel cartridge 2 and pure water cartridge 3 through its control means when the amount of fluid in the supply cartridge 4 reaches a predetermined level to achieve the fuel solution mixing means; step 104 where the monitoring unit 5 continues to monitor the level of solution mixture of fuel and pure water in the supply cartridge 4 through liquid level gauge 6; step 105 where the monitoring unit 5 controls the output of fuel from supply cartridge 4 to fluid feeding means according to the demands of fuel cell 1; and step 106 where the monitoring unit 5 monitors the fuel solution level in supply cartridge 4 through a liquid level gauge 6 to achieve the fluid metering means, and when the fuel solution level falls below the predetermined liquid level, the monitoring unit 5 selectively enters step 103.

In the aforesaid steps, the concentration of fuel solution is controlled by controlling the amount of fluid entering the supply cartridge 4 from fuel cartridge 2 and pure water cartridge 3 respectively, and the fluids from fuel cartridge 2 and pure water cartridge 3 could also enter a temporary storage area for full mixing before entering the supply cartridge 4.

Furthermore, the aforesaid fluid control valve can be a simple fluid switch control valve for selecting the opening or closing of fluid output from fuel cartridge 2 and pure water cartridge 3. However, the monitoring unit 5 could monitor the reduction of liquid level gauge 6 in fuel cartridge 2 and pure water cartridge 3 respectively to determine the output from fuel cartridge 2 and pure water cartridge 3 so as to determine whether the fluids entering supply cartridge 4 from fuel cartridge 2 and pure water cartridge 3 have reached the predetermined level.

A step 107 may be further added, where the monitoring unit 5 continues to monitor the concentration of fuel solution in supply cartridge 4 through a concentration detector 7. When the monitoring unit 5 determines through concentration detector 7 that the concentration of fuel solution in supply cartridge 4 falls below a predetermined level, it determines the amount of fuel needed from the fuel cartridge 2 through its logic decision means and selectively opens the fluid control valve of fuel cartridge 2 until the fuel cartridge 2 has fed the supply cartridge 4 a predetermined amount of fuel, and upon which, closes the fluid control valve of fuel cartridge 2 through its control means, thereby regulating the concentration of fuel solution in supply cartridge 4 to the desired level.

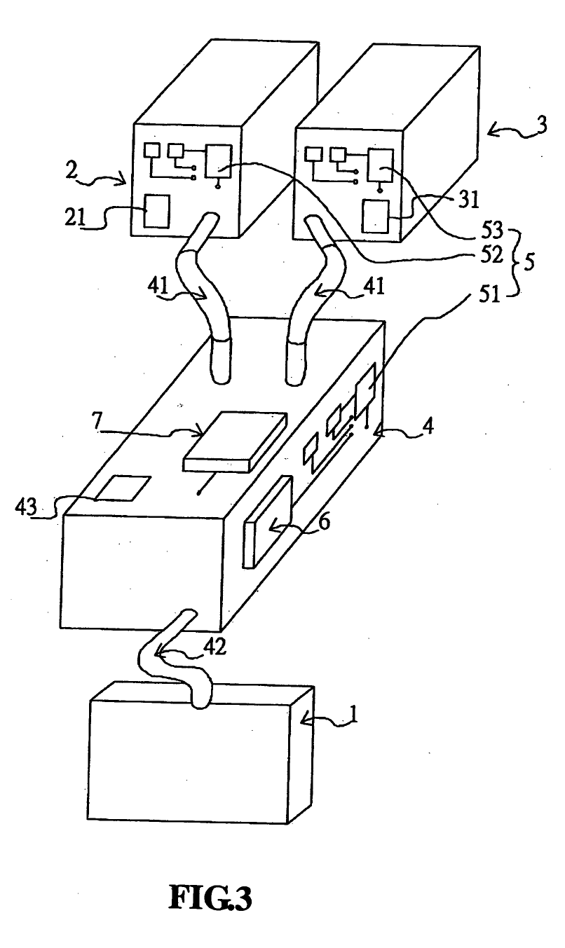

FIG. 3 shows a partial exploded view of a fuel cartridge monitoring device for fuel cells according to another embodiment of the invention. The fuel cartridge 2, pure water cartridge 3 and supply cartridge 4 (as shown in FIG. 1) of the fuel cartridge monitoring device herein have respectively fluid storage space, fluid inlet, and fluid outlet. In the example of the supply cartridge 4 of a methanol fuel cell that supplies specific concentration of methanol as shown in FIG. 3, the supply cartridge 4 comes with a plurality of inlets 41 and an outlet 42. The inlets 41 are respectively connected to the fuel cartridge 2 and pure water cartridge 3, while the outlet 42 is connected to the fuel cell 1, and the inlets 41 and outlet 42 have typical fluid circulation control structure, such as a valve that allows inlets 41 and outlet 42 to selectively circulate and seal the fluid. The monitoring unit 5 consists of a first local circuit 51 arranged on the exterior surface of supply cartridge 4 to control the inlets 41 and outlet 42 of supply cartridge 4 and monitor the liquid level gauge 6. The control flow process of the invention may be effected according to the embodiment just cited.

The monitoring unit 5 may further contain a second local circuit 52 and a third local circuit 53; the second local circuit 52 is disposed on the exterior surface of fuel cartridge 2 to monitor or control the electrical elements configured therein, and the third local circuit 53 is disposed on the exterior surface of pure water cartridge 3 to monitor or control the electrical elements configured therein.

In addition, the embodiments cited above may achieve metering means through inlets and outlet having flow control means without the use of a liquid level gauge.

According to the aforesaid embodiments, the supply cartridge 4 may be arranged with a concentration detector 7 having concentration detection means to detect the concentration of fuel in the fuel cartridge 4, and transmit such information to the monitoring unit 5 for it to determine the fuel concentration in the supply cartridge 4.

According to the aforesaid embodiments, the supply cartridge 4 may be configured with a first transmission port 43 which integrates the first local circuit 51 of monitoring unit 5 to allow the monitoring unit 5 to export through it information relating to the supply cartridge 4, including the height of fuel solution, the amount of fuel solution, or the concentration of fuel solution to an external system. For example, the first transmission port 43 can have a USB interface, 1394 interface, or any transmission interface used for data output by an electronic device, and the monitoring unit 5 can transfer the information on the concentration of fuel in supply cartridge 4 to a personal computer. Further, the fuel cartridge 2 and pure water cartridge 3 can have respectively a second transmission port 21 and a third transmission port 31, which respectively integrates the second local circuit 52 and the third local circuit 53 of monitoring unit 5 to allow the monitoring unit 5 to export through the second local circuit 52 and third local circuit 53 respectively information relating to fuel cartridge 2 and pure water cartridge 3 to an external system.

In the aforesaid embodiments, the first local circuit 51, second local circuit 52, and third local circuit 53 of monitoring unit 5 may be operated independently. Thus the fuel cartridge 2, pure water cartridge 3, and supply cartridge 4 may be independent units, where the supply cartridge 4 connects to fuel cartridge 2 and pure water cartridge 3 respectively through the inlet 41. Further, synergistic operation of the fuel cartridge 2, pure water cartridge 3, and supply cartridge 4 may be achieved by integrating the first local circuit 51, second local circuit 52 and third local circuit 53 through the monitoring unit 5.

In the aforesaid embodiments, the liquid level gauge 6 may have the means to display directly the liquid level to allow user to determine whether the fluid in fuel cartridge 2, pure water cartridge 3, or supply cartridge 4 is depleted.

A few embodiments of the invention have been disclosed, which however should not be construed as a limitation on the scope of claim. All modifications and alterations to the descriptions disclosed made by those familiar with the skill without departing from the spirits of the invention and appended claims shall remain within the protected scope and claims of the invention.

What is claimed is:

1. A fuel cartridge monitoring device for fuel cells, comprising:
a fuel cartridge filled with fuel having specific concentration;
a pure water cartridge filled with pure water;
a supply cartridge having space for storing fluid;
a monitoring unit that provides circuits for logic decision means and control means; and
a fuel cell;
wherein said fuel cartridge, pure water cartridge and supply cartridge have respectively fluid output control means, and said supply cartridge is connected to the fuel cartridge and the pure water cartridge, and said fuel cell is connected to the supply cartridge; through the logic decision means and control means of the monitoring unit, an amount of fluid in fuel cartridge and pure water cartridge selectively and respectively enters the supply cartridge and mixes into fuel solution of specific concentration, where an amount of the fuel solution is selectively output from the supply cartridge to the fuel cell.

2. The fuel cartridge monitoring device of claim 1, wherein the means to control the output of fluids from said fuel cartridge, pure water cartridge and supply cartridge are selectively achieved through a fluid control valve.

3. The fuel cartridge monitoring device of claim 2, wherein said fluid control valve is equipped with a fluid flow control means to achieve the means of fluid metering control.

4. The fuel cartridge monitoring device of claim 2, wherein said monitoring unit further comprises:
a fluid output control circuit; and
a liquid level monitoring circuit;
wherein said fluid output control circuit and liquid level monitoring circuit are arranged in the supply cartridge, and said fluid output control circuit selectively opens or closes the fluid control valve of supply cartridge; the liquid level monitoring circuit determines the amount of fuel solution in the supply cartridge.

5. The fuel cartridge monitoring device of claim 4, wherein said monitoring unit further comprises a transmission port; said transmission port being a data transmission interface.

6. The fuel cartridge monitoring device of claim 5, wherein said transmission port has selectively a USB interface, 1394 interface, or any transmission interface for data output by an electronic device.

7. The fuel cartridge monitoring device of claim 2, wherein said monitoring unit further comprises:
a plurality of fluid output control circuits; and
a plurality of liquid level monitoring circuits;
wherein said fluid output control circuits are respectively arranged in the fuel cartridge, pure water cartridge, and supply cartridge to selectively open or close the corresponding fluid control valve of fuel cartridge, pure water cartridge, and supply cartridge; the liquid level monitoring circuits determine the respective amount of fluid stored in the fuel cartridge, pure water cartridge, and supply cartridge.

8. The fuel cartridge monitoring device of claim 7, wherein said fuel cartridge, pure water cartridge, and supply cartridge contains respectively a transmission port; said transmission port being a data transmission interface.

9. The fuel cartridge monitoring device of claim 8, wherein said transmission port has selectively a USB interface, 1394 interface, or any transmission interface for data output by an electronic device.

10. The fuel cartridge monitoring device of claim 7, wherein the circuits of said monitoring unit arranged respectively in fuel cartridge, pure water cartridge, and supply cartridge operate independently.

11. The fuel cartridge monitoring device of claim 2, further comprising a liquid level gauge having the means to determine the height of liquid level.

12. The fuel cartridge monitoring device of claim 11, wherein said liquid level gauge further comprises a liquid level display means.

13. The fuel cartridge monitoring device of claim 2, wherein said supply cartridge further comprises a concentration detector having the means to detect the concentration of fluid.

14. A fuel cartridge monitoring device for fuel cells, comprising:
a fuel monitoring device for fuel cells consisting of a fuel solution mixing means, a fluid metering means, and a fluid feeding means;
a fuel cartridge for storing high concentration of liquid fuel;
a pure water cartridge for storing pure water;
a supply cartridge for storing solution mixture of fuel and pure water;
opening the fluid feeding means to allow the fluid in fuel cartridge and pure water cartridge to respectively enter the supply cartridge until the solution mixture of fuel and pure water reaches a predetermined level, and then closing the fluid feeding means to stop fluid supply from fuel cartridge and pure water cartridge;
a fluid metering means for monitoring the level of fuel solution in the supply cartridge; and
when the fluid metering means determines that the fuel solution level in the supply cartridge falls below a predetermined level, selectively opening said fluid feeding means.

15. The fuel cartridge monitoring device of claim 14, further comprising:
a monitoring unit consisting of fluid output control circuits and liquid level monitoring circuits for use by the fuel solution mixing means, fluid metering means, and fluid feeding means; and
said fuel cartridge, pure water cartridge, and supply cartridge having respectively fluid output control means; said supply cartridge being connected to the fuel cartridge and the pure water cartridge, and said fuel cell being connected to the supply cartridge; through the monitoring unit, an amount of fluid in fuel cartridge and pure water cartridge selectively and respectively entering the supply cartridge and mixed into fuel solution of specific concentration, where an amount of fuel solution is selectively output from the supply cartridge to the fuel cell.

16. The fuel cartridge monitoring device of claim 15, wherein the means to control the output of fluids from said fuel cartridge, pure water cartridge and supply cartridge are selectively achieved through a fluid control valve.

17. The fuel cartridge monitoring device of claim 16, wherein said fluid control valve is equipped with fluid flow control means to achieve the means of fluid metering control.

18. The fuel cartridge monitoring device of claim 15, wherein said fluid output control circuit and liquid level monitoring circuit are arranged in the supply cartridge, and said fluid output control circuit selectively opens or closes the fluid control valve of supply cartridge; the liquid level monitoring circuit determines the amount of fuel solution in the supply cartridge.

19. The fuel cartridge monitoring device of claim 15 wherein said fluid output control circuits are respectively arranged in the fuel cartridge, pure water cartridge, and supply cartridge to selectively open or close and corresponding fluid control valve of fuel cartridge, pure water cartridge, and supply cartridge; the liquid level monitoring circuits determine the respective amount of fluid stored in the fuel cartridge, pure water cartridge, and supply cartridge.

20. The fuel cartridge monitoring device of claim 15, further comprising a liquid level gauge having the means to determine the height of liquid level and thereby achieve fluid metering.

21. The fuel cartridge monitoring device of claim 15, further comprising a means to monitor the concentration of fuel solution in the supply cartridge.

22. The fuel cartridge monitoring device of claim 21, wherein the means to monitor the concentration of fuel solution in the supply cartridge further comprising:
providing information on the concentration of fuel solution in the supply cartridge to the monitoring unit; the monitoring unit carrying out logical decision means to determine the amount of fuel needed from the fuel cartridge and selectively open the fluid control valve of fuel cartridge; and the monitoring unit carrying out control means to close the fluid control valve of fuel cartridge when the amount of fuel flowing from fuel cartridge into the supply cartridge reaches a predetermined level.
